(19) United States
(12) Patent Application Publication
(10) Pub. No.: US 2021/0192452 A1
(43) Pub. Date: Jun. 24, 2021

(54) DATA COLLECTION SYSTEM AND METHOD FOR A FLEET OF COMMERCIAL VEHICLES

(71) Applicant: Ford Global Technologies, LLC, Dearborn, MI (US)

(72) Inventors: Andrew J. Murray, Colchester (GB); Richard Craven, Chelmsford (GB)

(73) Assignee: Ford Global Technologies, LLC, Dearborn, MI (US)

(21) Appl. No.: 17/121,681

(22) Filed: Dec. 14, 2020

(30) Foreign Application Priority Data
Dec. 18, 2019 (GB) 1918751.7

(51) Int. Cl. G06Q 10/08; G06Q 10/06

(52) U.S. Cl. CPC G06Q 10/08355; G06Q 10/06311

(57) ABSTRACT

A data collection system for a fleet of commercial vehicles, the system comprising: a fleet manager system, the fleet manager system configured to receive logistics data from a controller in each of the commercial vehicles that monitors logistics data comprising loadspace capacity, a delivery/pick-up schedule, location data and, in at least one of the vehicles, a battery charge state.

### CROSS-REFERENCE TO RELATED APPLICATIONS

This application claims priority to and the benefit of UK patent application No. 1918751.7, filed Dec. 18, 2019, which is hereby incorporated herein in its entirety.

### FIELD

This application relates to data collection system for a fleet of commercial vehicles. The disclosure also relates to a method of managing a fleet of commercial vehicles.

### BACKGROUND

Commercial vehicle data collection systems are known to monitor logistics data for a fleet of commercial vehicles. Logistics data monitored by previously-considered systems include location (e.g. GPS) data, loadspace capacity and route information (e.g. a delivery/pick-schedule) for each vehicle in the fleet.

In such previously-considered systems, the data collection system may propose the consolidation of cargo from two vehicles into a single vehicle in some circumstances.

For example, where cargo in a first vehicle is intended for delivery at a location which is off-route for the first vehicle, but which is on-route for a second vehicle, and wherein the second vehicle has sufficient spare loadspace capacity for said cargo.

While such systems generally increase the efficiency of a fleet of vehicles, particular problems arise with fleets including electric vehicles. Where traditional internal combustion engines fuelled by e.g. petrol or diesel can be refuelled in a matter of minutes, electric vehicles can take several hours to recharge. This can add significant delay to a delivery or pick-up.

Additionally, many cities now include low emission zones or congestion charge zones that penalise or prevent entry of vehicles having certain traditional internal combustion engines. If a delivery or pick-up location falls within such a zone it may not be desirable, or even possible, to carry out the delivery or pick-up using certain vehicles within a fleet.

The present disclosure attempts to address some of the drawbacks associated with previously-considered data collection systems.

### SUMMARY

In accordance with a first aspect of the present disclosure there is provided a data collection system for a fleet of commercial vehicles, the system comprising:
a fleet manager system, the fleet manager system configured to receive logistics data from a controller in each of the commercial vehicles that monitors logistics data comprising loadspace capacity, a delivery/pick-up schedule, location data and, in at least one of the vehicles, a battery charge state.

In some examples, the system comprises a fleet manager system and a controller in each of the commercial vehicles that monitors logistics data comprising loadspace capacity, a delivery/pick-up schedule, location data and, in at least one of the vehicles, a battery charge state, wherein the controller transmits the logistics data to the fleet manager system.

Optionally, the fleet manager system is further configured to:
receive a new delivery or pick-up request comprising new cargo data and new location data;
identify a first dispatched vehicle (e.g. already departed from a depot) containing the new cargo for delivery or having sufficient spare loadspace capacity for pick-up of the new cargo;
determine whether or not the new location falls within an effective range of the first dispatched vehicle based on logistics data received from the controller of the first dispatched vehicle; and
if the fleet manager system determines that the new location falls within the effective range of the first dispatched vehicle,
dispatch the first dispatched vehicle to the new location to fulfil the new delivery or pick-up request.

The fleet manager system may be further configured to:
identify a second dispatched vehicle that can fulfil the new delivery or pick-up request based on predetermined criteria, if the fleet manager system determines that the new location falls outside the effective range of the first dispatched vehicle.

The predetermined criteria may comprise:
that the effective range of the first dispatched vehicle overlaps with an effective range of the second dispatched vehicle, such that a rendezvous point may be set in the overlap;
that the rendezvous point may be set such that the sum of a first distance between the first dispatched vehicle and the rendezvous point, and a second distance between the rendezvous point and a charging station are within the effective range of the first dispatched vehicle;
that the rendezvous point may be set such that the sum of a third distance between the second vehicle and the rendezvous point, a fourth distance between the rendezvous point and the new location, and a fifth distance between the new location and the or another charging station, is within the effective range of the second dispatched vehicle; and
that the second dispatched vehicle has sufficient spare loadspace capacity to accommodate the new cargo.

Additionally or alternatively, the predetermined criteria may comprise:
that the effective range of the first dispatched vehicle overlaps with an effective range of the second dispatched vehicle, such that a rendezvous point may be set in the overlap;
that the rendezvous point may be set such that the sum of a first distance between the first dispatched vehicle and the rendezvous point, and a second distance between the rendezvous point and a charging station are within the effective range of the first dispatched vehicle;
that the rendezvous point may be set such that the sum of a third distance between the second vehicle and the new location, a fourth distance between the new location and the rendezvous point, and a fifth distance between the rendezvous point and a charging station, is within the effective range of the second dispatched vehicle; and
that the second dispatched vehicle has sufficient spare loadspace capacity to accommodate the new cargo.

The fleet manager system may be configured to:
receive a new delivery or pick-up request comprising new cargo data and new location data;
identify a first dispatched vehicle containing the new cargo for delivery or having sufficient spare loadspace capacity for pick-up of the new cargo;
determine a set of feasible routes between the first dispatched vehicle and the new location;
determine whether the first dispatched vehicle is an electric vehicle; and
if the fleet manager system determines that all of the feasible routes in the set of feasible routes pass through a congestion charge zone or a low emissions zone, and that the first dispatched vehicle is not an electric vehicle,
identify a second dispatched vehicle that can fulfil the new delivery or pick-up request based on predetermined criteria.

The predetermined criteria may comprise:
that the effective range of the first dispatched vehicle overlaps with an effective range of the second dispatched vehicle, such that a rendezvous point may be set in the overlap;
that the rendezvous point may be set such that a first distance between the first dispatched vehicle and the rendezvous point is within the effective range of the first dispatched vehicle;
that the rendezvous point may be set such that the sum of a second distance between the second vehicle and the rendezvous point, a third distance between the rendezvous point and the new location, and a fourth distance between the new location and a charging station, is within the effective range of the second dispatched vehicle; and
that the second dispatched vehicle has sufficient spare loadspace capacity to accommodate the new cargo.

Additionally or alternatively, the predetermined criteria may comprise:
that the effective range of the first dispatched vehicle overlaps with an effective range of the second dispatched vehicle, such that a rendezvous point may be set in the overlap;
that the rendezvous point may be set such that a first distance between the first dispatched vehicle and the rendezvous point is within the effective range of the first dispatched vehicle;
that the rendezvous point may be set such that the sum of a second distance between the second vehicle and the new location, a third distance between the new location and the rendezvous point, and a fourth distance between the rendezvous point and a charging station, is within the effective range of the second dispatched vehicle; and
that the second dispatched vehicle has sufficient spare loadspace capacity to accommodate the new cargo.

In accordance with a second aspect of the present disclosure there is provided a method of managing a fleet of commercial vehicles comprising the steps of:
providing a fleet manager system; and
providing a controller in each of the commercial vehicles that monitors logistics data comprising loadspace capacity, a delivery/pick-up schedule, location data and, in at least one of the vehicles, a battery charge state,
wherein the controller transmits the logistics data to the fleet manager system.

The method may further comprise the steps of:
receiving, at the fleet manager system, a new delivery or pick-up request comprising new cargo data and new location data;
identifying a first dispatched vehicle containing the new cargo for delivery or having sufficient spare loadspace capacity for pick-up of the new cargo;
determining whether or not the new location falls within an effective range of the first dispatched vehicle based on logistics data received from the controller of the first dispatched vehicle; and
if the new location falls within the effective range of the first dispatched vehicle,
dispatching the first dispatched vehicle to the new location to fulfil the new delivery or pick-up request.

The method may further comprise the step of:
identifying a second dispatched vehicle that can fulfil the new delivery or pick-up request based on predetermined criteria, if the new location falls outside the effective range of the first dispatched vehicle.

The predetermined criteria may comprise:
that the effective range of the first dispatched vehicle overlaps with an effective range of the second dispatched vehicle, such that a rendezvous point may be set in the overlap;
that the rendezvous point may be set such that the sum of a first distance between the first dispatched vehicle and the rendezvous point, and a second distance between the rendezvous point and a charging station are within the effective range of the first dispatched vehicle;
that the rendezvous point may be set such that the sum of a third distance between the second vehicle and the rendezvous point, a fourth distance between the rendezvous point and the new location, and a fifth distance between the new location and the or another charging station, is within the effective range of the second dispatched vehicle; and
that the second dispatched vehicle has sufficient spare loadspace capacity to accommodate the new cargo.

Additionally or alternatively, the predetermined criteria may comprise:
that the effective range of the first dispatched vehicle overlaps with an effective range of the second dispatched vehicle, such that a rendezvous point may be set in the overlap;
that the rendezvous point may be set such that the sum of a first distance between the first dispatched vehicle and the rendezvous point, and a second distance between the rendezvous point and a charging station are within the effective range of the first dispatched vehicle;
that the rendezvous point may be set such that the sum of a third distance between the second vehicle and the new location, a fourth distance between the new location and the rendezvous point, and a fifth distance between the rendezvous point and a charging station, is within the effective range of the second dispatched vehicle; and
that the second dispatched vehicle has sufficient spare loadspace capacity to accommodate the new cargo.

The method may further comprise the steps of:
receiving, at the fleet manager system, a new delivery or pick-up request comprising new cargo data and new location data;
identifying a first dispatched vehicle containing the new cargo for delivery or having sufficient spare loadspace capacity for pick-up of the new cargo;
determining a set of feasible routes between the first dispatched vehicle and the new location;
determining whether the first dispatched vehicle is an electric vehicle; and
if all of the feasible routes in the set of feasible routes pass through a congestion charge zone or a low emissions zone, and the first dispatched vehicle is not an electric vehicle,
identifying a second dispatched vehicle that can fulfil the new delivery or pick-up request based on predetermined criteria.

The predetermined criteria may comprise:
that the effective range of the first dispatched vehicle overlaps with an effective range of the second dispatched vehicle, such that a rendezvous point may be set in the overlap;
that the rendezvous point may be set such that a first distance between the first dispatched vehicle and the rendezvous point is within the effective range of the first dispatched vehicle;
that the rendezvous point may be set such that the sum of a second distance between the second vehicle and the rendezvous point, a third distance between the rendezvous point and the new location, and a fourth distance between the new location and a charging station, is within the effective range of the second dispatched vehicle; and
that the second dispatched vehicle has sufficient spare loadspace capacity to accommodate the new cargo.

Additionally or alternatively, the predetermined criteria may comprise:
that the effective range of the first dispatched vehicle overlaps with an effective range of the second dispatched vehicle, such that a rendezvous point may be set in the overlap;
that the rendezvous point may be set such that a first distance between the first dispatched vehicle and the rendezvous point is within the effective range of the first dispatched vehicle;
that the rendezvous point may be set such that the sum of a second distance between the second vehicle and the new location, a third distance between the new location and the rendezvous point, and a fourth distance between the rendezvous point and a charging station, is within the effective range of the second dispatched vehicle; and
that the second dispatched vehicle has sufficient spare loadspace capacity to accommodate the new cargo.

In accordance with a third aspect of the present disclosure there is provided non-transitory computer readable medium comprising instructions which, when executed by a processor (e.g. a processor in a fleet manager system), cause performance of a method in accordance with the second aspect.

### BRIEF DESCRIPTION OF THE DRAWINGS

The disclosure will now be described by way of example with reference to the accompanying drawings, in which:

FIG. 1 schematically illustrates a data collection system according to an embodiment of the disclosure;

FIG. 2 schematically illustrates a first cargo consolidation method enabled by the data collection system of the present disclosure;

FIG. 3 schematically illustrates a second cargo consolidation method enabled by the data collection system of the present disclosure;

FIG. 4 schematically illustrates a third cargo consolidation method enabled by the data collection system of the present disclosure;

FIG. 5 shows a flowchart illustrating a first method of managing a fleet of vehicles according to an embodiment of the disclosure; and

FIG. 6 shows a flowchart illustrating a second method of managing a fleet of vehicles according to an embodiment of the disclosure.

### DETAILED DESCRIPTION

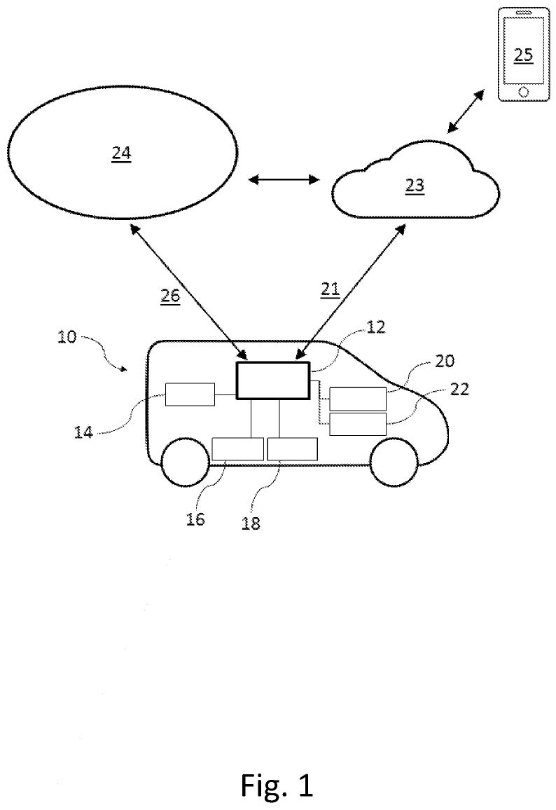

FIG. 1 schematically shows a data collection system in accordance with an embodiment of the disclosure. The system comprises a plurality of vehicles, with one indicated at 10. The vehicle 10 comprises a controller 12. The controller 12 is communicatively coupled to sensors within the vehicle to receive respective inputs therefrom.

The controller 12 is coupled to a volume sensor 14. The volume sensor 14 monitors the available (i.e. unoccupied) volume within a loadspace of the vehicle 10. The volume sensor 14 may be an optical sensor, for example a camera, or a sensor capable of remotely measuring volume (e.g. LIDAR, RADAR, sonar, ultrasound, etc.).

The controller 12 is also coupled to a weight sensor 16. The weight sensor 16 monitors the weight of cargo within the loadspace of the vehicle 10. The weight sensor 16 may comprise one or more weight sensitive tiles incorporated into a floor of the loadspace.

The controller 12 is also coupled to a battery charge sensor 18. The battery charge sensor 18 monitors the remaining charge level of a battery of the vehicle. The battery is a motive source for the vehicle, and may be the sole motive source or a battery in a hybrid electric vehicle.

The controller 12 is also coupled to a location sensor 20. The location sensor 20 monitors the location of the vehicle 10, and sends location data (e.g. GPS data) to the controller.

The controller 12 is also coupled to a memory unit 22 on board the vehicle. The memory unit 22 contains schedule information for the vehicle, e.g. a plurality of delivery/pick up locations linked by a route. The schedule information may be initially set at a central distribution centre (e.g. a depot) for the vehicle 10 prior to dispatch of the vehicle, with updates being transmitted to the memory unit 22 in real-time while the vehicle 10 is dispatched for delivery/pick-up. Alternatively, updates may be transmitted to a driver of the vehicle 10 (e.g. via mobile telecommunications device), and the updates may be manually input to the memory unit 22 by the driver. In a further alternative arrangement, the memory unit 22 may be a part of a mobile telecommunications device carried by a driver of the vehicle 10, with the controller coupled to the memory unit 22 via a wired or wireless (e.g. Bluetooth®) connection to the mobile telecommunications device.

Each of the inputs received by the controller 12 may be broadly categorised as ‘logistics data’. The controller 12 consolidates the logistics data, and makes any calculations necessary before transmitting the logistics data to a fleet manager system 24. The fleet manager system 24 comprises one or more processors operable to receive instructions and process data.

Examples of calculations include the calculation of effective vehicle range based on the data from the battery charge sensor 18 and the location sensor 20, and the calculation of spare cargo capacity based on data from the volume sensor 14 and the weight sensor 16.

As an example of vehicle effective range calculation: this could, in some examples, be as coarse as a simple range circle centred on the vehicle and derived from the maximum driving distance at the current battery charge level derived from the battery charge sensor 18. In other examples, a more detailed effective range shape could be derived using road and/or traffic data obtained from the location sensor 20. The location sensor could also modify the effective range shape using topographical or geographical data stored in the location sensor 20. For even greater detail, the effective range shape could be modified using data from the volume sensor 14 and the weight sensor 16, as effective range will generally decrease as the weight of cargo in the loadspace increases.

As an example of a spare cargo capacity calculation: the volume sensor 14 may detect that there is space for cargo in the loadspace, but the weight sensor 16 may detect that the total weight of cargo already in the loadspace meets (or exceeds a threshold percentage of) a weight limit of the vehicle 10. In this case, the controller 12 may determine that the vehicle has no spare cargo capacity. Alternatively, spare cargo capacity could be based on a single one of the volume sensor 14 and the weight sensor 16.

The controller 12 sends the consolidated logistics data to the fleet manager system 24 through a two-way communication channel indicated by double arrow 26. While only a single vehicle 10 is shown in FIG. 1, it will be appreciated that a plurality of such vehicles would be present in practice.

The controller may optionally send the consolidated logistics data (or a subset thereof) to an online marketplace 23, through a two-way communication channel indicated by double arrow 21. The online marketplace 23 may be accessed by a customer, for example through a telecommunications device 25. Customers may place new delivery or pick-up requests (comprising at least new cargo data and new location data) in the online marketplace 23 for processing by the fleet manager system 24. If the fleet manager system 24 determines that a vehicle, or vehicles (see below), can fulfil the new delivery or pick-up request, the customer may receive a notification that their new delivery or pick-up request has been accepted. The fleet manager system 24 and/or the controller 12 may provide additional data to the customer, such as real-time location data regarding the vehicle or vehicles fulfilling their request, or the estimated time remaining until delivery/pick-up.

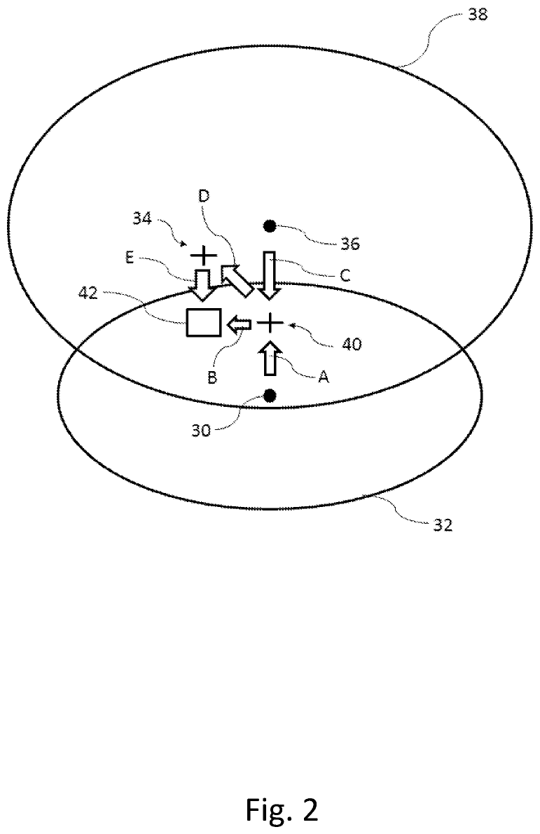

FIG. 2 schematically illustrates a cargo consolidation method enabled by the data collection system of the present disclosure.

A first vehicle 30 in the fleet has a first effective range 32 as shown. The effective range 32 may be calculated in the controller of the first vehicle as described above, or it may be calculated by the fleet manager system 24.

After the first vehicle 30 has been dispatched (e.g. has left a depot and is currently out en route for delivery/pick-up) a new delivery request is received by the fleet manager system 24. The new cargo specified in the new cargo data of the new delivery request corresponds to cargo contained in the loadspace of the first vehicle 30. The new location data of the new delivery request indicates that the new cargo should be delivered to new location 34.

The fleet manager system 24 compares the new location 34 with the first effective range 32 and determines that the new location 34 lies outside the first effective range 32, and so the first vehicle 30 is unable to fulfil the new delivery request without running out of battery charge. Following this determination, the fleet manager system 24 searches for other vehicles in the fleet capable of rendezvousing with the first vehicle 30 and fulfilling the new delivery request without running out of battery charge.

The fleet manager system 24 determines that a second vehicle 36 (with a second effective range 38) in the fleet is able to fulfil the new delivery request based on the following criteria:

i) the first effective range 32 and second effective range 38 overlap, such that a rendezvous point 40 may be set in the overlap;
ii) the rendezvous point 40 may be set such that the sum of a first distance A (between the first vehicle 30 and the rendezvous point 40) and a second distance B (between the rendezvous point 40 and a charging station 42) are within the first effective range 32;
iii) the rendezvous point 40 may be set such that the sum of a third distance C (between the second vehicle and the rendezvous point 40), a fourth distance D (between the rendezvous point 40 and the new location 34) and a fifth distance E (between the new location 34 and the charging station 42) are within the second effective range 38; and
iv) the second vehicle 36 has sufficient spare loadspace capacity to accommodate the new cargo.

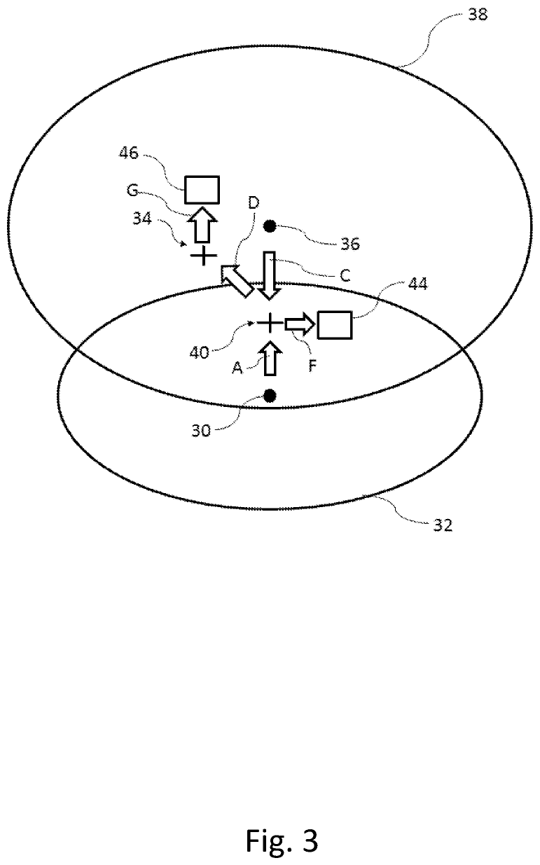

Alternatively, the first and second vehicles may recharge their batteries at different charging stations. In this case, the fleet manager system 24 determines that a second vehicle is able to make the delivery as shown in FIG. 3 and described below. Like reference numerals from FIG. 2 are retained for clarity.

The fleet manager system 24 determines that a second vehicle 36 (with a second effective range 38) in the fleet is able to fulfil the new delivery request based on the following criteria:

i) the first effective range 32 and second effective range overlap, such that a rendezvous point 40 may be set in the overlap;
ii) the rendezvous point 40 may be set such that the sum of a first distance A (between the first vehicle 30 and the rendezvous point 40) and a second distance F (between the rendezvous point 40 and a first charging station 44) are within the first effective range 32;
iii) the rendezvous point 40 may be set such that the sum of a third distance C (between the second vehicle and the rendezvous point 40), a fourth distance D (between the rendezvous point 40 and the new location 34) and a fifth distance G (between the new location 34 and a second charging station 46) are within the second effective range 38; and
iv) the second vehicle 36 has sufficient spare loadspace capacity to accommodate the new cargo.

While the examples described above with respect to FIGS. 2 and 3 use a delivery request for clarity of explanation, it should be clear that ‘delivery request’ could be substituted with ‘pick-up request’. A new pick-request comprises at least new cargo data and new location data (similarly to a new delivery request) with the new cargo data specifying new cargo to be picked up and the new location data specifying a new location at which the new cargo is to be picked up.

In such cases, the second vehicle would need to be able to visit the new location for pick-up of the new cargo before proceeding to the rendezvous point with the first vehicle to transfer the new cargo from the second vehicle to the first vehicle. Therefore, the second vehicle would need to be able to travel between its current location, the new location, the rendezvous point and a charging station without exceeding its effective range (and running out of battery charge), and the first vehicle would need to be able to travel between its current location, the rendezvous point and a charging station without exceeding its effective range (and running out of battery charge).

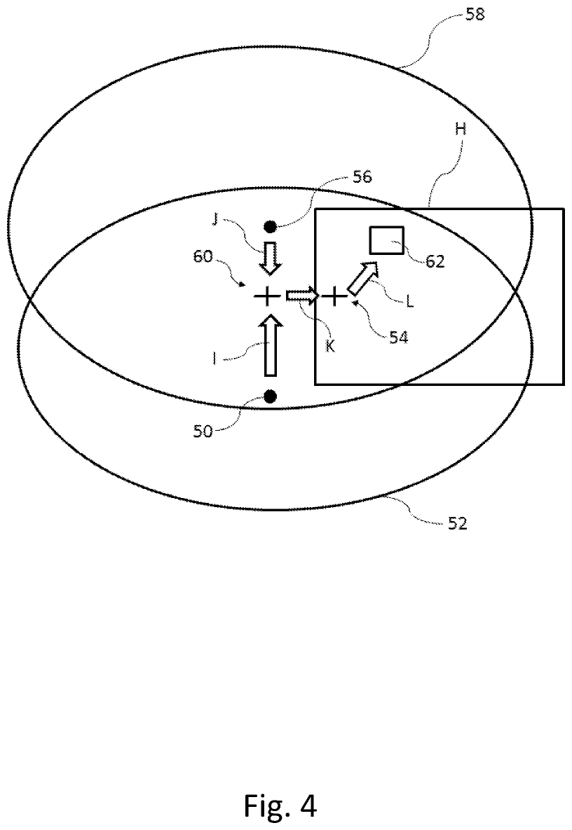

Some fleets of vehicles may comprise both vehicles with internal combustion engines and electric vehicles. In these cases the vehicles with internal combustion engines would be outfitted as shown in FIG. 1, except that the battery charge sensor 18 is replaced by a fuel level sensor (effective range can be calculated in the controller or by the fleet manager system in a similar manner as for electric vehicles within the fleet). FIG. 4 schematically illustrates a cargo consolidation method enabled by the data collection system of the present disclosure for such mixed vehicle fleets.

A first vehicle 50 in the fleet has a first effective range 52 as shown. The effective range 32 may be calculated in the controller of the first vehicle as described above, or it may be calculated by the fleet manager system 24. The first vehicle 50 has a traditional internal combustion engine (e.g. fuelled by petrol or diesel).

After the first vehicle 50 has been dispatched (e.g. has left a depot and is currently out en route for delivery/pick-up) a new delivery request is received by the fleet manager system 24. The new cargo specified in the new cargo data of the new delivery request corresponds to cargo contained in the loadspace of the first vehicle 50. The new location data of the new delivery request specifies that the new cargo should be delivered to a new location 54.

The fleet manager system 24 compares the new location 54 with the first effective range 52 and determines that the new location 54 lies within the first effective range 52. However, following this determination the fleet manager system 24 compares the new location 54 with geographical coverage data of known low emission zones or congestion charge zones. Such data can be programmed into the fleet manager system 24, or the data can be downloaded in real-time from an internet source that is continuously or periodically updated. In this example, the fleet manager system 24 determines that the new location 54 lies within a low emission zone H.

Following this determination, the fleet manager system 24 searches for other vehicles in the fleet capable of rendezvousing with the first vehicle 50 and fulfilling the new delivery request without running out of battery charge.

The fleet manager system 24 determines that a second vehicle 56 (with a second effective range 58) in the fleet is able to fulfil the new delivery request based on the following criteria:

i) the first effective range 52 and second effective range 58 overlap, such that a rendezvous point 60 may be set in the overlap;
ii) the rendezvous point 60 may be set such that a first distance I (between the first vehicle 50 and the rendezvous point 60) is within the first effective range 52;
iii) the rendezvous point 60 may be set such that the sum of a second distance J (between the second vehicle 56 and the rendezvous point 60), a third distance K (between the rendezvous point 60 and the new location 64) and a fourth distance L (between the new location 64 and the charging station 62) are within the second effective range 58; and
iv) the second vehicle 56 has sufficient spare loadspace capacity to accommodate the new cargo.

It will be appreciated that, although preferable, steps i) and ii) above can be omitted, as the first vehicle can be quickly refuelled to get to a rendezvous point outside of the first effective range. The crucial steps are iii) and iv), as electric vehicles typically take much longer to recharge than internal combustion engine vehicles, and charging stations are typically rarer than petrol stations.

While the example described above with respect to FIG. 4 uses a delivery request for clarity of explanation, it should be clear that ‘delivery request’ could be substituted with ‘pick-up request’. In such cases, the second vehicle would need to be able to visit the new location for pick-up of the new cargo before proceeding to the rendezvous point with the first vehicle to transfer the new cargo from the second vehicle to the first vehicle. Therefore, the second vehicle would need to be able to travel between its current location, the new location, the rendezvous point and a charging station without exceeding its effective range (and running out of battery charge).

Further, while in the example described above with respect to FIG. 4 the new location of the new delivery/pick up request falls within the low emission zone H, in some examples the new location may not actually fall directly within a low emission zone or congestion charge zone, yet said low emission zone or congestion charge zone may nevertheless prevent the first dispatched vehicle from fulfilling the delivery/pick-up request. For example, the first dispatched vehicle may be located on a first side of the low emission zone or congestion charge zone and the new location may fall on a second, opposing side of the low emission zone or congestion charge zone, such that all feasible routes between the first dispatched vehicle and the new location pass through a portion of the low emission zone or congestion charge zone. In such examples, the fleet manager system 24 may determine a set of feasible routes between the first dispatched vehicle and the new location, and determine whether all of the feasible routes pass through a low emission zone or congestion charge zone.

In this context a ‘feasible route’ means a route that may be carried out by the vehicle without the vehicle running out of battery charge/fuel, i.e. a route falling within the effective range of the vehicle. Clearly, where the new location falls within a low emission zone or congestion charge zone, all feasible routes to the new location must pass through a portion of the low emission zone or congestion charge zone.

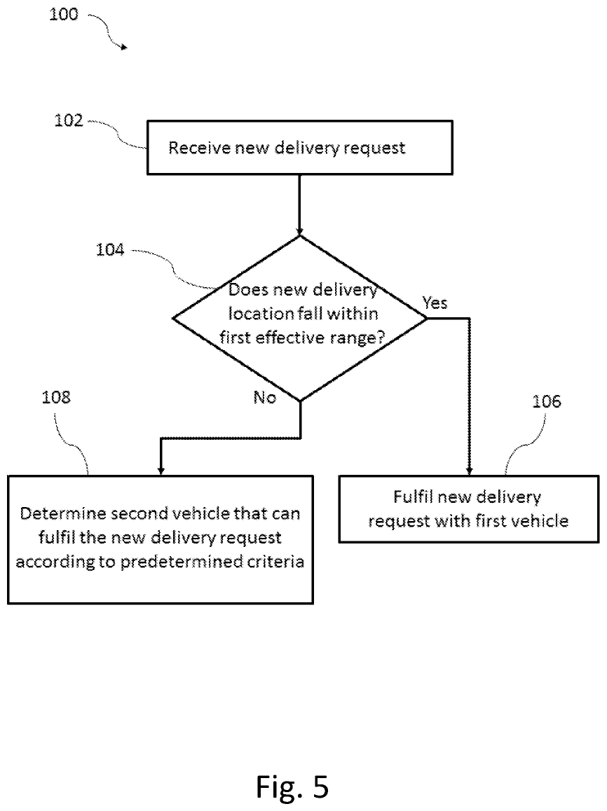

FIG. 5 shows a flowchart 100 illustrating a method of managing a fleet of vehicles according to an embodiment of the disclosure. In a first step 102, the method comprises the step of receiving, at a fleet manager system a new delivery request comprising new cargo data and new location data. Following step 102, the method moves on to step 104, wherein the method comprises the step of determining whether or not the new location falls within the first effective range of a first vehicle within the fleet that contains the new cargo.

If the fleet manager system determines that the new location does fall within the first effective range, the method moves on to step 106, wherein the method comprises the step of dispatching the first vehicle to the new location to deliver the new cargo and fulfil the new delivery request.

If the fleet manager system determines that the new location does not fall within the first effective range, the method moves on to step 108, wherein the method comprises determining a second vehicle the can fulfil the new delivery request according to predetermined criteria (e.g. the predetermined criteria discussed above with respect to FIGS. 2 and 3).

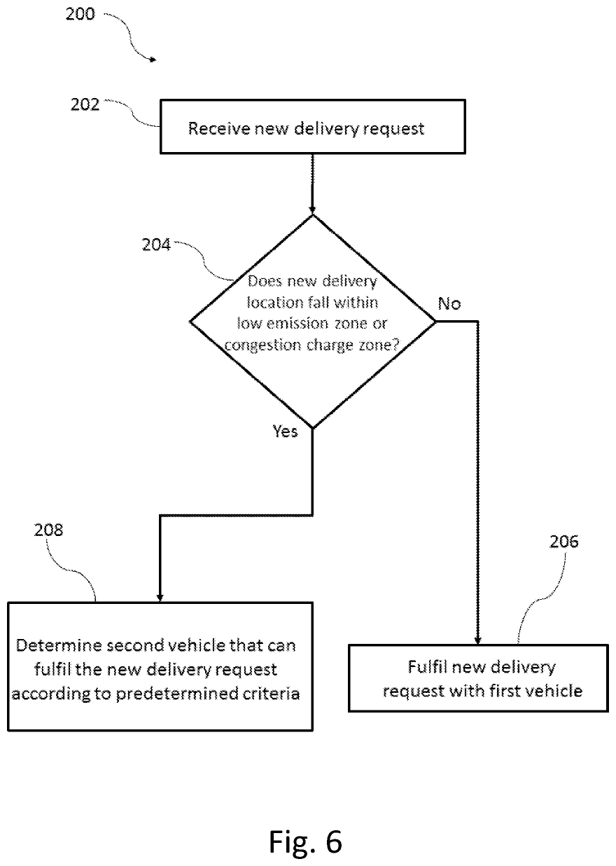

FIG. 6 shows a flowchart 200 illustrating a method of managing a fleet of vehicles according to an embodiment of the disclosure. In a first step 202, the method comprises the step of receiving, at a fleet manager system a new delivery request comprising new cargo data and new location data. Following step 202, the method moves on to step 204, wherein the method comprises the step of determining whether or not the new location falls within a low emission zone or a congestion charge zone.

If the fleet manager system determines that the new location does not fall within a low emission zone or a congestion charge zone, the method moves on to step 206, wherein the method comprises the step of dispatching a first vehicle that contains the new cargo to the new location to deliver the new cargo and fulfil the new delivery request.

If the fleet manager system determines that the new location does fall within a low emission zone or a congestion charge zone, the method moves on to step 208, wherein the method comprises determining a second vehicle the can fulfil the new delivery request according to predetermined criteria (e.g. the predetermined criteria discussed above with respect to FIG. 4).

As discussed above with respect to FIG. 4, while in the example method described above with respect to FIG. 6 the new location of the new delivery/pick up request falls within a low emission zone or congestion charge zone, in some examples the new location may not actually fall directly within a low emission zone or congestion charge zone, yet said low emission zone or congestion charge zone may nevertheless prevent the first dispatched vehicle from fulfilling the delivery/pick-up request. For example, the first dispatched vehicle may be located on a first side of the low emission zone or congestion charge zone and the new location may fall on a second, opposing side of the low emission zone or congestion charge zone, such that all feasible routes between the first dispatched vehicle and the new location pass through a portion of the low emission zone or congestion charge zone. In such examples, the method may comprise the step of determining a set of feasible routes between the first dispatched vehicle and the new location, and determining whether all of the feasible routes pass through a low emission zone or congestion charge zone.

In this context a ‘feasible route’ means a route that may be carried out by the vehicle without the vehicle running out of battery charge/fuel, i.e. a route falling within the effective range of the vehicle. Clearly, where the new location falls within a low emission zone or congestion charge zone, all feasible routes to the new location must pass through a portion of the low emission zone or congestion charge zone.

It will be appreciated by those skilled in the art that although the disclosure has been described by way of example with reference to several embodiments it is not limited to the disclosed embodiments and that alternative embodiments could be constructed without departing from the scope of the disclosure as defined in the appended claims.

For example, in the discussion above the phrase ‘such that a rendezvous point may be set in the overlap’ is intended to mean a feasible rendezvous point. For example, effective ranges may overlap in areas where a rendezvous is not possible (e.g. places where vehicles are forbidden from stopping, such as motorways).

As stated repeatedly above, while the specific examples in the Figures use a delivery request for clarity of explanation, it should be clear that ‘delivery request’ could be substituted with ‘pick-up request’. In such cases, the second vehicle would need to be able to visit the new location for pick-up of the new cargo before proceeding to the rendezvous point with the first vehicle to transfer the new cargo from the second vehicle to the first vehicle. Therefore, the second vehicle would need to be able to travel between its current location, the new location, the rendezvous point and a charging station without exceeding its effective range (and running out of battery charge), and the first vehicle would need to be able to travel between its current location, the rendezvous point and a charging station without exceeding its effective range (and running out of battery charge).

1. A data collection system for a fleet of commercial vehicles, the system comprising:
a fleet manager system, the fleet manager system configured to receive logistics data from a controller in each of the commercial vehicles that monitors logistics data comprising loadspace capacity, a delivery/pick-up schedule, location data and, in at least one of the vehicles, a battery charge state.

2. A data collection system in accordance with claim 1, wherein the fleet manager system is configured to:
receive a new delivery or pick-up request comprising new cargo data and new location data;
identify a first dispatched vehicle containing the new cargo for delivery or having sufficient spare loadspace capacity for pick-up of the new cargo;
determine whether or not the new location falls within an effective range of the first dispatched vehicle based on logistics data received from the controller of the first dispatched vehicle; and
if the fleet manager system determines that the new location falls within the effective range of the first dispatched vehicle,
dispatch the first dispatched vehicle to the new location to fulfil the new delivery or pick-up request.

3. A data collection system in accordance with claim 2, wherein if the fleet manager system determines that the new location falls outside the effective range of the first dispatched vehicle, the fleet manager system is further configured to:
identify a second dispatched vehicle that can fulfil the new delivery or pick-up request based on predetermined criteria.

4. A data collection system in accordance with claim 3, wherein the predetermined criteria comprises:
that the effective range of the first dispatched vehicle overlaps with an effective range of the second dispatched vehicle, such that a rendezvous point may be set in the overlap;
that the rendezvous point may be set such that the sum of a first distance between the first dispatched vehicle and the rendezvous point, and a second distance between the rendezvous point and a charging station are within the effective range of the first dispatched vehicle;
that the rendezvous point may be set such that the sum of a third distance between the second vehicle and the rendezvous point, a fourth distance between the rendezvous point and the new location, and a fifth distance between the new location and the or another charging station, is within the effective range of the second dispatched vehicle; and
that the second dispatched vehicle has sufficient spare loadspace capacity to accommodate the new cargo.

5. A data collection system in accordance with claim 3, wherein the predetermined criteria comprises:
that the effective range of the first dispatched vehicle overlaps with an effective range of the second dispatched vehicle, such that a rendezvous point may be set in the overlap;
that the rendezvous point may be set such that the sum of a first distance between the first dispatched vehicle and the rendezvous point, and a second distance between the rendezvous point and a first charging station are within the effective range of the first dispatched vehicle;
that the rendezvous point may be set such that the sum of a third distance between the second vehicle and the new location, a fourth distance between the new location and the rendezvous point, and a fifth distance between the rendezvous point and the or another charging station, is within the effective range of the second dispatched vehicle; and
that the second dispatched vehicle has sufficient spare loadspace capacity to accommodate the new cargo.

6. A data collection system in accordance with claim 1, wherein the fleet manager system is configured to:
receive a new delivery or pick up request comprising new cargo data and new location data;
identify a first dispatched vehicle containing the new cargo for delivery or having sufficient spare loadspace capacity for pick-up of the new cargo;
determine a set of feasible routes between the first dispatched vehicle and the new location;
determine whether the first dispatched vehicle is an electric vehicle; and
if the fleet manager system determines that all of the feasible routes in the set of feasible routes pass through a congestion charge zone or a low emissions zone, and that the first dispatched vehicle is not an electric vehicle,
identify a second dispatched vehicle that can fulfil the new delivery or pick-up request based on predetermined criteria.

7. A data collection system in accordance with claim 6, wherein the predetermined criteria comprises:
that the effective range of the first dispatched vehicle overlaps with an effective range of the second dispatched vehicle, such that a rendezvous point may be set in the overlap;
that the rendezvous point may be set such that a first distance between the first dispatched vehicle and the rendezvous point is within the effective range of the first dispatched vehicle;
that the rendezvous point may be set such that the sum of a second distance between the second vehicle and the rendezvous point, a third distance between the rendezvous point and the new location, and a fourth distance between the new location and a charging station, is within the effective range of the second dispatched vehicle; and
that the second dispatched vehicle has sufficient spare loadspace capacity to accommodate the new cargo.

8. A data collection system in accordance with claim 6, wherein the predetermined criteria comprises:
that the effective range of the first dispatched vehicle overlaps with an effective range of the second dispatched vehicle, such that a rendezvous point may be set in the overlap;
that the rendezvous point may be set such that a first distance between the first dispatched vehicle and the rendezvous point is within the effective range of the first dispatched vehicle;
that the rendezvous point may be set such that the sum of a second distance between the second vehicle and the new location, a third distance between the new location and the rendezvous point, and a fourth distance between the rendezvous point and a charging station, is within the effective range of the second dispatched vehicle; and
that the second dispatched vehicle has sufficient spare loadspace capacity to accommodate the new cargo.

9. A method of managing a fleet of commercial vehicles comprising the steps of:
providing a fleet manager system; and
providing a controller in each of the commercial vehicles that monitors logistics data comprising loadspace capacity, a delivery/pick-up schedule, location data and, in at least one of the vehicles, a battery charge state,
wherein the controller transmits the logistics data to the fleet manager system.

10. A method in accordance with claim 9, further comprising the steps of:
receiving, at the fleet manager system, a new delivery or pick-up request comprising new cargo data and new location data;
identifying a first dispatched vehicle containing the new cargo for delivery or having sufficient spare loadspace capacity for pick-up of the new cargo;
determining whether or not the new location falls within an effective range of the first dispatched vehicle based on logistics data received from the controller of the first dispatched vehicle; and
if the new location falls within the effective range of the first dispatched vehicle,
dispatching the first dispatched vehicle to the new location to fulfil the new delivery or pick-up request.

11. A method in accordance with claim 10, wherein if the new location falls outside the effective range of the first dispatched vehicle, the method further comprises the step of:
identifying a second dispatched vehicle that can fulfil the new delivery or pick-up request based on predetermined criteria.

12. A method in accordance with claim 11, wherein the predetermined criteria comprises:
that the effective range of the first dispatched vehicle overlaps with an effective range of the second dispatched vehicle, such that a rendezvous point may be set in the overlap;
that the rendezvous point may be set such that the sum of a first distance between the first dispatched vehicle and the rendezvous point, and a second distance between the rendezvous point and a charging station are within the effective range of the first dispatched vehicle;
that the rendezvous point may be set such that the sum of a third distance between the second vehicle and the rendezvous point, a fourth distance between the rendezvous point and the new location, and a fifth distance between the new location and the or another charging station, is within the effective range of the second dispatched vehicle; and
that the second dispatched vehicle has sufficient spare loadspace capacity to accommodate the new cargo.

13. A method in accordance with claim 11, wherein the predetermined criteria comprises:
that the effective range of the first dispatched vehicle overlaps with an effective range of the second dispatched vehicle, such that a rendezvous point may be set in the overlap;
that the rendezvous point may be set such that the sum of a first distance between the first dispatched vehicle and the rendezvous point, and a second distance between the rendezvous point and a charging station are within the effective range of the first dispatched vehicle;
that the rendezvous point may be set such that the sum of a third distance between the second vehicle and the new location, a fourth distance between the new location and the rendezvous point, and a fifth distance between the rendezvous point and the or another charging station, is within the effective range of the second dispatched vehicle; and
that the second dispatched vehicle has sufficient spare loadspace capacity to accommodate the new cargo.

14. A method in accordance with claim 9, further comprising the steps of:
receiving, at the fleet manager system, a new delivery or pick-up request comprising new cargo data and new location data;
identifying a first dispatched vehicle containing the new cargo for delivery or having sufficient spare loadspace capacity for pick-up of the new cargo;
determining a set of feasible routes between the first dispatched vehicle and the new location;
determining whether the first dispatched vehicle is an electric vehicle; and
if all of the feasible routes in the set of feasible routes pass through a congestion charge zone or a low emissions zone, and the first dispatched vehicle is not an electric vehicle,
identifying a second dispatched vehicle that can fulfil the new delivery request based on predetermined criteria.

15. A method in accordance with claim 14, wherein the predetermined criteria comprises:
that the effective range of the first dispatched vehicle overlaps with an effective range of the second dispatched vehicle, such that a rendezvous point may be set in the overlap;
that the rendezvous point may be set such that a first distance between the first dispatched vehicle and the rendezvous point is within the effective range of the first dispatched vehicle;
that the rendezvous point may be set such that the sum of a second distance between the second vehicle and the rendezvous point, a third distance between the rendezvous point and the new location, and a fourth distance between the new location and a charging station, is within the effective range of the second dispatched vehicle; and
that the second dispatched vehicle has sufficient spare loadspace capacity to accommodate the new cargo.

16. A method in accordance with claim 14, wherein the predetermined criteria comprises:
that the effective range of the first dispatched vehicle overlaps with an effective range of the second dispatched vehicle, such that a rendezvous point may be set in the overlap;
that the rendezvous point may be set such that a first distance between the first dispatched vehicle and the rendezvous point is within the effective range of the first dispatched vehicle;
that the rendezvous point may be set such that the sum of a second distance between the second vehicle and the new location, a third distance between the new location and the rendezvous point, and a fourth distance between the rendezvous point and a charging station, is within the effective range of the second dispatched vehicle; and
that the second dispatched vehicle has sufficient spare loadspace capacity to accommodate the new cargo.

17. (canceled)
